(19) United States
(12) Patent Application Publication
(10) Pub. No.: US 2015/0001259 A1
(43) Pub. Date: Jan. 1, 2015

(54) APPARATUS FOR TRANSFERRING A FLUID TO A DISPENSING MECHANISM

(71) Applicant: John Nguyen, Garland, TX (US)

(72) Inventor: John Nguyen, Garland, TX (US)

(21) Appl. No.: 13/931,308

(22) Filed: Jun. 28, 2013

(51) Int. Cl. B05B 15/00

(52) U.S. Cl. CPC B05B 15/005
USPC 222/464.2

(57) ABSTRACT

An apparatus comprises at least one singular end comprising a top end and a bottom end. The top end is configured to engage a distal end of a draw tube of a fluid dispensing mechanism for a container and to enable fluid to pass from the bottom end to the draw tube. At least one tubular member is in flexible engagement with the bottom end. The tubular member is configured to extend outward from the bottom end towards a bottom of a wall of a container for the fluid dispensing mechanism and to enable fluid in proximity of the bottom of the wall to pass to the bottom end.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to transportation of materials. More particularly, the invention relates to transportation of material through tubes.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Tubes are commonly used in conjunction with pumps to transport materials (most commonly fluids) from within a container to without the container. However, these systems are generally inefficient in retrieving materials at the very bottom of containers, causing waste.

One currently known solution shows a multitube catheter including two or more tubes fused together to form one catheter tube shaft. However, this system is not applicable to non-catheter use. Another currently known solution teaches of a container and associated dispenser for liquid configured to dispense residual liquid from the container after the bulk of liquid has been dispensed from the container. However, this method is inefficient for retrieving all of the liquid from the bottom of a container. Still another known solution discloses of a spray bottle with flexible tubing and including a head, a weight and a nozzle. However, this method is also inefficient for retrieving all of the liquid from the bottom of a container. An approach that allowed for efficient retrieval of materials at the bottom of containers would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary device for transporting materials, in accordance with an embodiment of the present invention;

FIG. 2 is an illustration of another exemplary device for transporting materials, in accordance with an embodiment of the present invention;

FIG. 3 is an illustration of an exemplary device for transporting materials, in accordance with an embodiment of the present invention;

FIG. 4A is an illustration of an exemplary device for transporting materials, in accordance with an embodiment of the present invention;

FIG. 4B is bottom view of one tube of an exemplary device for transporting materials, in accordance with an embodiment of the present invention; and

FIG. 5 is an illustration of an exemplary device for transporting materials and a top view of a securing device, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

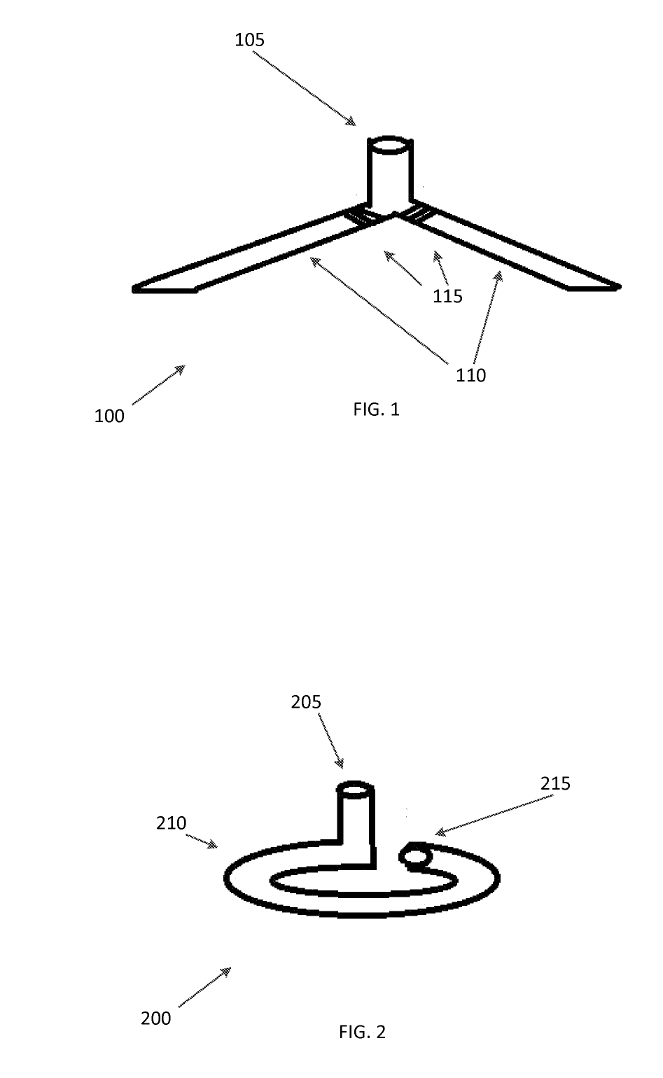

FIG. 1 is an illustration of an exemplary device for transporting materials, in accordance with an embodiment of the present invention. The device may have a singular end 105. The singular end 105 may be designed to connect to a tube. In some embodiments, the singular end 105 may be composed of a flexible material, including, without limitation, rubber, plastic, latex, lambskin, polyurethane, and polyisoprene that may allow the singular end 105 to fit over a tube and form a connection. In some of these embodiments, the singular end 105 may extend to a length beyond what would be minimally required to form a connection with a tube. In the present embodiment, a preferred exemplary length of tubing may be approximately one inch, but may vary in a preferred range from ½ inch to 2 inches depending on the size of the container. The singular end 105 may be of any length so as to allow the device to slide up and down a tube to fit a container in which the device may be situated. In alternative embodiments, the singular end 105 may be composed of a rigid material. In some of these alternative embodiments, the singular end 105 may include, without limitation, notches or cavities that may allow the singular end 105 to form a connection with a tube. In at least some of these alternative embodiments, the singular end 105 may be sized to fit inside a tube.

In the present embodiment, the singular end 105 may be joined at its base with two tubes 110. In other embodiments, the singular end 105 may be joined at its base with three or more tubes 110. In still other embodiments, the singular end 105 may be joined at its based with a single tube 110. The tubes 110 may be joined to the base of the singular end 105 by a joining means 115. In some embodiments, the joining means 115 may be a flexible material, such as, without limitation, rubber, plastic, latex, lambskin, polyurethane, and polyisoprene. In some of these embodiments, the flexibility of the joining means 115 may allow the tubes 110 to conform to an area an which the device may be situated. In the present embodiment, each individual tube 110 may have a single flexible joining means 115. In alternative embodiments, the tubes 110 may have multiple flexible joining means 115 so as to allow the tubes 110 to be more flexible. In other alternative embodiments, the joining means 115 may be substantially rigid. In the present embodiment, the tubes 110 extend from the base of the singular end 105 in opposite directions. In alternative embodiments, the tubes may extend from the base of the singular end 105 in any directions. In some of these alternative embodiments, the tubes 110 may be any distance from each other. The singular end 105 and tubes 110 may be composed of a rigid material, such as, without limitation, plastic. In other embodiments, the singular end 105 and tubes 110 may be composed of a flexible material, including, without limitation, rubber or plastic. in some embodiments, a rigid material for tubes 110 may be glass or metal. In many embodiments, the singular end 105 and tubes 110 may be tubular in shape. In alternative embodiments, the singular end 105 and tubes 110 may be hexagonal, octagonal, or any other shape. In the present embodiment, the distal ends of tubes 110 may be cut at an angle to form an oval opening facing downward. In other embodiments, the distal ends of tubes 110 may be cut at an angle to form a circular opening or an oval opening facing upward or to a side.

FIG. 2 is an illustration of another exemplary device for transporting materials, in accordance with an embodiment of the present invention. In the present embodiment, a singular end 205 may be joined with an elongate tube 210. The elongate tube 210 may be of any length. In the present embodiment an exemplary length of tube 210 is approximately 6 inches, although depending on the size of the container, a preferred range of 3-8 inches may be appropriate. In the present embodiment, a preferred material for tube 210 comprises, but not limited to, rubber In some embodiments a metal wire or some bendable material may be installed inside the rubber tube so that the tube extension is able to be bended and molded into a specific shape to reach a specific area. In some embodiments, the elongate tube 210 may extend to any walls and/or floor of a container in which the device may be situated. The elongate tube 210 may allow for a second end 215 at the floor and/or wall of a container in which the device may be situated. The second end 215 may thereby be positioned to efficiently retrieve materials from the floor of a container.

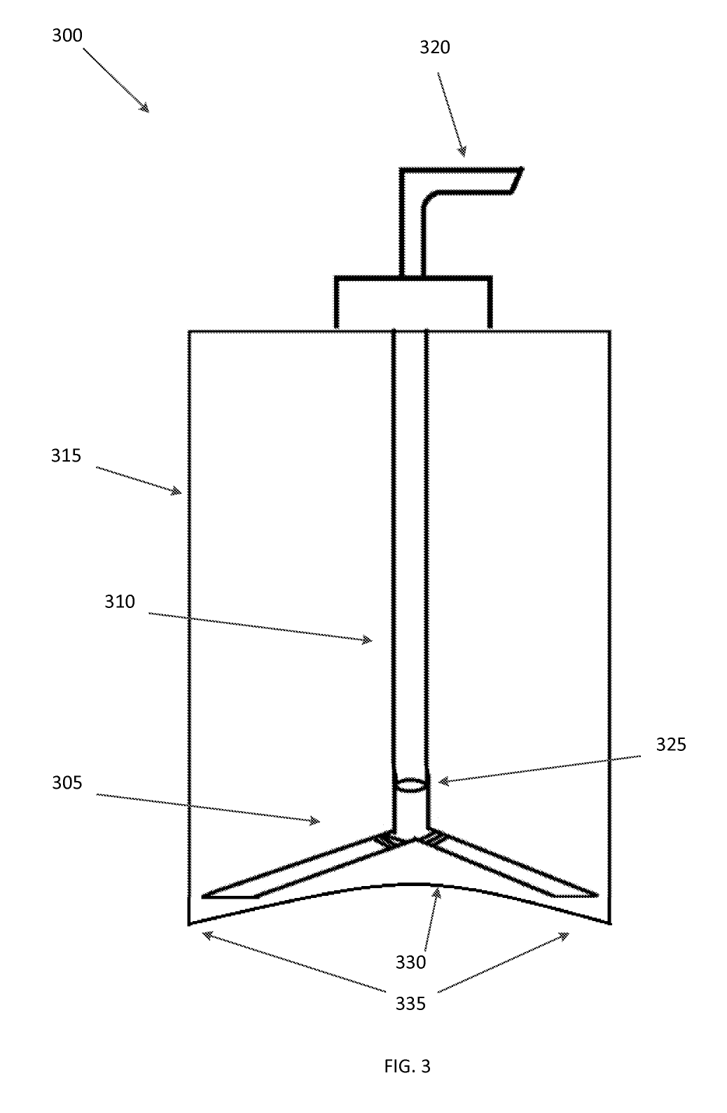

FIG. 3 is an illustration of an exemplary device for transporting materials, in accordance with an embodiment of the present invention. In the present embodiment, a material transportation device 305 may be joined with a draw tube 310 to allow fluid or other material from a container 315 to flow to a nozzle 320. In alternative embodiments, the draw tube 310 may be an extension of the device 305, thus eliminating the need for a connection 325 between the device 305 and the tube 310. The device 305 may extend to the walls and/or floor of the container 315 so as to effectively collect all materials from the container 315. The device may be compatible with any kind of tube 310, any kind of container 315, and any kind of nozzle 320. In alternate embodiments, device 305 may be secured to tube 310 by a clamping mechanism. In a non-limiting example, the clamping mechanism may be like a hose clamp with a screw mechanism or a spring mechanism for tightening.

As a non-limiting example, a container 315 may hold soap. The floor 330 of the soap container 315 may be concave. After most of the soap has been dispensed from the container 315, the remaining soap may settle in the corners of the container 335. The tubes 110 of the device may extend to the corners 335 of the container 315 and efficiently collect the remaining soap.

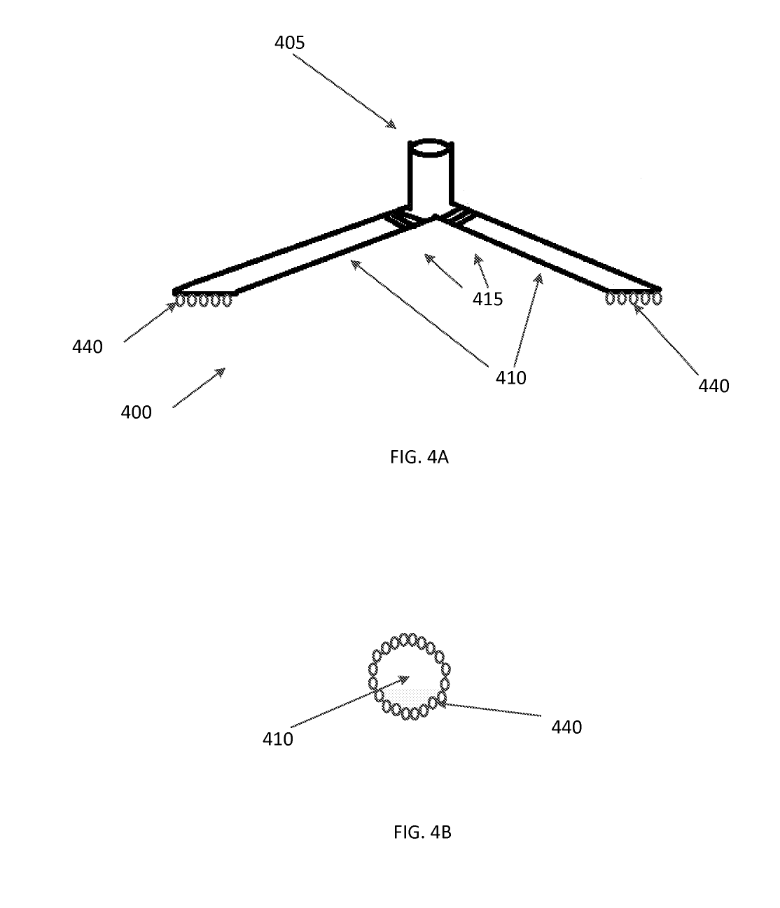

FIG. 4A is an illustration of an exemplary device for transporting materials, in accordance with an embodiment of the present invention. The device may have a singular end 405. The singular end 405 may be designed to connect to a tube. In some embodiments, the singular end 405 may be composed of a flexible material, including, without limitation, rubber, plastic, latex, lambskin, polyurethane, and polyisoprene that may allow the singular end 405 to fit over a tube and form a connection as shown in FIG. 3. In some of these embodiments, the singular end 405 may extend to a length beyond what would be minimally required to form a connection with a tube. The singular end 405 may be of any length so as to allow the device to slide up and down a tube to fit a container in which the device may be situated.

In the present embodiment, the singular end 405 may be joined at its base with two tubes 410. In other embodiments, the singular end 405 may be joined at its base with three or more tubes 410. In still other embodiments, the singular end 405 may be joined at its based with a single tube 410. The tubes 410 may be joined to the base of the singular end 405 by a joining means 415. In the present embodiment, the tubes 410 extend from the base of the singular end 405 in opposite directions. In the present embodiment, nubs or protrusions 440 encircle the open distal end of tubes 410. Nubs 440 preferable may be formed from the wall of tubes 410. In other embodiments, nubs 440 may be attached to tubes 410 by for example, but not limited to, gluing. In some other embodiments, nubs 440 may be a part of an assembly that slips over the ends of tubes 410 much like end 405 slips over a tube. Nubs 440 may provide a means for sweeping the bottom of a container to increase the effectiveness of removing the material in the bottom of the container. In one embodiment, a user may rotate device by rotating the tube to which it is joined to. In another alternate embodiment, pump nozzle 320, shown in FIG. 3, may be configured to rotate tube 310 and thus device 400, when nozzle 320 is depressed.

FIG. 4B is bottom view of one tube of an exemplary device for transporting materials, in accordance with an embodiment of the present invention. Nubs 440 surround the opening of tubes 410. In other embodiments nubs 440 may only surround only a portion of the opening. Nubs 440 may be shaped in a variety of ways. Shapes for nubs 440 may include, but not limited to, cylinders, rounds, ovals, cubes, etc.

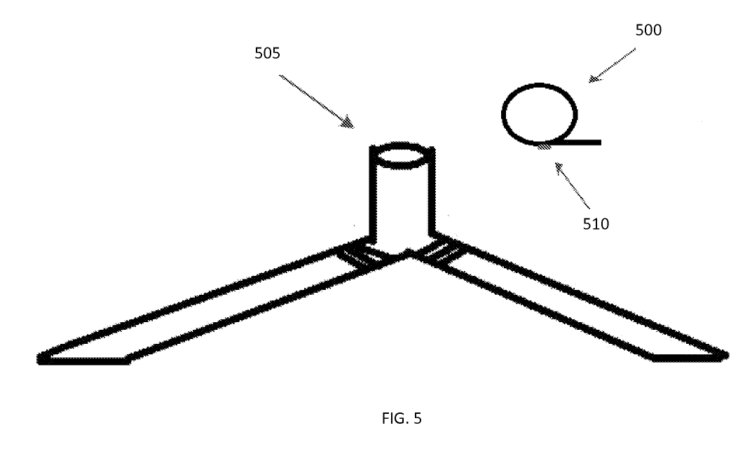

FIG. 5 is an illustration of an exemplary device for transporting materials and a top view of a securing device 500, in accordance with an embodiment of the present invention. The device may have a singular end 505. The singular end 505 may be designed to connect to a draw tube, as illustrated by way of example in FIG. 3. In some embodiments a fastener may be incorporated to create a tight connection between the singular end 505 and the draw tube. For example without limitation, in the present embodiment, securing device 500 may be a zip tie type fastener that may be used as additional security to connect the device to the draw tube. Securing device 500 comprises a screw 510 that may be tightened or loosened depending on the direction in which the screw 510 is turned to manually manipulate the securing device 500 to loosen or tighten the securing device 500. It is contemplated that in some alternate embodiments a multiplicity of suitable fasteners may be used such as, but not limited to, clamping mechanisms, a hose clamp, a screw mechanism, a spring mechanism, elastic sleeves, threaded mechanisms, etc. Securing devices such as, but not limited to, securing device 500 may be used in various different embodiments of the present invention. Also, some embodiments may be implemented without securing devices.

In alternative embodiments, a series of two or more ends may replace the singular end 105 so as to allow for multiple output possibilities. In some alternative embodiments, the singular end 105 or multiple ends may have flaps or other restrictive means that allow flow to an individual end when a user elects to draw from the individual end. Users may restrict flow to certain output ends through use of the flaps or other restrictive means in these alternative embodiments. As a non-limiting example, a bathroom sink may have two faucets and one soap dispenser. The soap dispenser may have two output ends which each attach to a nozzle 320, one for each faucet. When a user engages one of the nozzles 320, a flap associated with that nozzle 320 may open to allow flow to the nozzle 320. A flap associate with the other nozzle 320 may not open so that soap may not issue from the other nozzle 320.

In some alternative embodiments, output ends 105, tubes 110, and connecting means may be distributed separately. Users may thereby be able to replace individual parts on an individual basis. In some embodiments, the output ends 105 and tubes 110 may connect to each other through means of, without limitation, cavities, notches, fitting over each other, or any combination of these means. In alternative embodiments, a separate connecting means may be used. The separate connecting means may be, without limitation, a flexible material designed to fit over or create a connection between the output ends 105 and the tubes 110, a paste or other fluid that may create a seal between the output ends 105 and the tubes 110, or a rigid material designed to fit over or create a connection between the output ends 105 and the tubes 110.

In some embodiments, the device may be used to mix materials for drinking or other purposes. Individual tubes 110 may extend to pools of different materials. The materials may be combined at the singular end 105 and may be transported through tubes or otherwise from the singular end 105 of the device. As a non-limiting example, a first tube 110 would be situated in a container of oil and a second tube 110 would be situated in a container of vinegar. The two liquids would be retrieved concurrently and a mixture of the two would be sent out the singular end 105 of the device to be used in cooking. In another non-limiting example, embodiment of the present invention could be used in bars, restaurants, or any other locations where drinks may be served. Servers may use embodiments of the present invention to mix two or more drinks Embodiments of the present invention may have any number of tubes 110.

In some embodiments, tubes 110 may extend from a singular end 105 in a direction substantially perpendicular to the singular end 105. In alternative embodiments, tubes 110 may extend from a singular end 105 in a direction substantially perpendicular to the singular end 105 and then bend so as to extend in a direction substantially parallel to the singular end 105. In other alternative embodiments, tubes 110 may extend from a singular end 105 or from multiple output ends in any directions so as to efficiently reach materials in containers or natural sources in which the embodiments may be situated.

In other embodiments, a tube 110 may have mechanisms along the tube's 110 body or at the tube's 110 end to provide improved maneuverability. For example, a tube 110 may have wheels attached at the tube's 110 end to allow the tube 110 to more easily slide along a bottom of a container in which the embodiment may be situated.

Embodiments of the present invention may be sold individually in different sizes or sold in packs, e.g. 3-5 various sizes. Other embodiments may be sold together with empty containers to which the embodiments may have been fitted. Some embodiments may be sold together with filled containers of various materials or products. For example, embodiments may be sold in a bottle of windex window cleaning spray with an embodiment installed inside the bottle. Embodiments may also be sold individually or in packages along with packages or cases of containers.

None of the embodiments of the present invention are suitable for use as a catheter.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing transportation of materials according to the present invention will be apparent to those skilled in the art. Various aspects of the invention have been described above by way of illustration, and the specific embodiments disclosed are not intended to limit the invention to the particular forms disclosed. The particular implementation of the transportation of materials may vary depending upon the particular context or application. By way of example, and not limitation, the transportation of materials described in the foregoing were principally directed to contained material implementations; however, similar techniques may instead be applied to materials in natural sources and other open spaces, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
at least one singular end comprising a top end and a bottom end, said top end being configured to engage a distal end of a draw tube of a fluid dispensing mechanism for a container and to enable fluid to pass from said bottom end to the draw tube; and
at least one tubular member being in flexible engagement with said bottom end, said tubular member being configured to extend outward from said bottom end towards a bottom of a wall of a container for the fluid dispensing mechanism and to enable fluid in proximity of the bottom of the wall to pass to said bottom end.

2. The apparatus as recited in claim 1, further comprising joining means for flexibly engaging said at least one tubular member to said bottom end.

3. The apparatus as recited in claim 1, further comprising a second tubular member being in flexible engagement with said bottom end, said second tubular member being configured to extend outward from said bottom end towards the bottom of the wall of the container for the fluid dispensing mechanism and to enable fluid in proximity of the bottom of the wall to pass to said bottom end.

4. The apparatus as recited in claim 3, further comprising joining means for flexibly engaging said second tubular member to said bottom end.

5. The apparatus as recited in claim 3, in which said singular end, said one tubular member and said second tubular member form an inverted Y shape.

6. The apparatus as recited in claim 3, in which distal ends of said one tubular member and said second tubular member each are cut at an angle to form an opening facing downward.

7. The apparatus as recited in claim 6, in which distal ends of said one tubular member and said second tubular member each further comprise nubs.

8. The apparatus as recited in claim 7, in which said nubs surround said openings.

9. The apparatus as recited in claim 1, in which said singular end engages the distal end of the draw tube by slipping over the draw tube.

10. An apparatus comprising:
a container being configured to contain a volume of fluid;
a fluid dispensing mechanism in engagement with said container, said fluid dispensing mechanism comprising a nozzle assembly from which a fluid may be dispensed, and a draw tube, in engagement with said nozzle assembly, being configured to extend into said container for carrying fluid to said nozzle assembly;
at least one singular end comprising a top end and a bottom end, said top end being configured to engage a distal end of said draw tube and to enable fluid to pass from said bottom end to the draw tube; and
at least one tubular member being in flexible engagement with said bottom end, said tubular member being configured to extend outward from said bottom end towards a bottom of a wall of said container and to enable fluid in proximity of said bottom of said wall to pass to said bottom end.

11. The apparatus as recited in claim 10, further comprising joining means for flexibly engaging said at least one tubular member to said bottom end.

12. The apparatus as recited in claim 10, further comprising a second tubular member being in flexible engagement with said bottom end, said second tubular member being configured to extend outward from said bottom end towards said bottom of the wall and to enable fluid in proximity of the bottom of the wall to pass to said bottom end.

13. The apparatus as recited in claim 12, further comprising joining means for flexibly engaging said second tubular member to said bottom end.

14. The apparatus as recited in claim 12, in which said singular end, said one tubular member and said second tubular member form an inverted Y shape.

15. The apparatus as recited in claim 12, in which distal ends of said one tubular member and said second tubular member each are cut at an angle to form an opening facing downward.

16. The apparatus as recited in claim 15, in which distal ends of said one tubular member and said second tubular member each further comprise nubs.

17. The apparatus as recited in claim 16, in which said nubs surround said openings.

18. The apparatus as recited in claim 10, in which said singular end engages said distal end of said draw tube by slipping over said draw tube.

19. An apparatus comprising:
a container being configured to contain a volume of fluid;
a fluid dispensing mechanism in engagement with said container, said fluid dispensing mechanism comprising a nozzle assembly from which a fluid may be dispensed, and a draw tube, in engagement with said nozzle assembly, being configured to extend into said container for carrying fluid to said nozzle assembly;
at least one singular end comprising a top end and a bottom end, said top end being configured to engage a distal end of said draw tube and to enable fluid to pass from said bottom end to the draw tube, in which said singular end engages said distal end of said draw tube by slipping over said draw tube;
a first tubular member being in flexible engagement with said bottom end, said tubular member comprising a rigid material and being configured to extend outward from said bottom end towards a bottom of a wall of said container and to enable fluid in proximity of the bottom of the wall to pass to said bottom end, a distal end of said first tubular member being cut at an angle to form an opening facing downward;
first joining means for flexibly engaging said first tubular member to said bottom end;
a second tubular member being in flexible engagement with said bottom end, said second tubular member comprising a rigid material and being configured to extend outward from said bottom end towards said bottom of the wall and to enable fluid in proximity of said bottom of said wall to pass to said bottom end, a distal end of said second tubular member being cut at an angle to form an opening facing downward, in which said singular end, said first tubular member and said second tubular member form an inverted Y shape;
second joining means for flexibly engaging said second tubular member to said bottom end

20. The apparatus as recited in claim 19, in which distal ends of said first tubular member and said second tubular member each further comprise nubs surrounding said openings.
